(19) United States
(12) Patent Application Publication
(10) Pub. No.: US 2026/0281072 A1
(43) Pub. Date: Sep. 17, 2026

(54) EMBEDDED UNIVERSAL INTEGRATED CIRCUIT CARD, CORRESPONDING SYSTEM ARCHITECTURE, MANAGING METHOD, COMMUNICATION PROTOCOL AND COMPUTER PROGRAM PRODUCT

(71) Applicant: STMicroelectronics International N.V., Geneva (CH)

(72) Inventors: Gennaro Balbi, Napoli (IT); Giulio Follero, Pozzuoli (IT); Nicola Fattoruso, Gragnano (IT)

(21) Appl. No.: 19/539,816

(22) Filed: Feb. 13, 2026

(30) Foreign Application Priority Data
Mar. 12, 2025 (IT) 102025000005080

(51) Int. Cl. H04L 51/224

(52) U.S. Cl. CPC H04L 51/224

(57) ABSTRACT

An embedded Universal Integrated Circuit Card (eUICC) configured to store notifications generated upon a profile operation execution in the eUICC, and comprising a processor configured to manage the notifications in the eUICC. The processor is configured to remove one or more notifications upon receiving a removing command. The removing command is configured to command removal of selected notifications stored in the eUICC, the selection of the notifications being determined through a selection argument of the removing command, the selection of the notifications determined through the selection argument comprising selecting all the notifications stored in the eUICC for deletion.

### CROSS-REFERENCE TO RELATED APPLICATIONS

This application is a translation of and claims the priority benefit of Italian patent application number 102025000005080, filed on Mar. 12, 2025, entitled “Embedded Universal Integrated Circuit Card, corresponding system architecture, managing method, communication protocol and computer program product,” which is hereby incorporated herein by reference to the maximum extent allowable by law.

### TECHNICAL FIELD

The description relates to integrated circuit cards, in particular to techniques for managing profiles in a eUICC, comprising generating on the card notifications to be sent to entities, in particular remote servers, when a profile operation is performed, comprising removing the notifications from the card, in particular after they have been sent.

One or more embodiments can be applied to integrated circuit cards such as, for instance, embedded UICCs, eUICCs, in particular Consumer cards or IoT cards.

### BACKGROUND

Integrated circuit cards such as Universal Integrated Circuit Cards, UICCs are widely used in a variety of contexts and applications such as in mobile terminals (mobile network devices) in order to facilitate establishing a connection with the Global System for Mobile Communications, GSM or the Universal Mobile Telecommunications System, UMTS networks, maintaining the integrity and security of personal data.

Embedded UICCs, eUICCs are a type of integrated circuit card based on architectural standards published by the GSM Association, GSMA and configured to facilitate a secure storage of one or more SIM (“Subscriber Identity Module”) card profiles, each of such one or more SIM card profiles comprising unique identifiers and cryptographic keys used by a cellular network service providers in order to uniquely identify each of the profiles.

For instance, such profiles may be used in a mobile network device comprising a corresponding eUICC, thus, enabling such mobile network device to register and securely communicate via the cellular network.

In this regard, the specification GSMA Specification Group Profile (SGP).31, SGP.32 embedded SIM (eSIM) for IoT and GSMA SGP.21, SGP.22 eUICC regarding the eUICC cards are known.

The GSMA SGP.21 and SGP.31 define requirements and architectures to enable the remote provisioning and management of the eUICC in IoT and Consumer Devices. GSMA SGP.22 and SGP.32 are the technical specifications that describe the overall architecture of the eUICC IoT and Consumer system.

In the eSIM for Consumer Devices, a Local Profile Assistant, LPA is embedded within the eSIM device to manage the profiles, handling communication with remote provisioning servers, e.g., SM-DP+.

In this regard, in FIG. 1 it is shown a schematic representation of a system for managing profiles in consumer eUICC cards 10′, where the data preparation server 13, which is specifically a SM-DP+, i.e., Subscription Manager Data Preparation-enhanced compared to the SM-DP in SGP.02, interacts directly with the local equipment 14, e.g., a mobile telephone or smartphone, and specifically with a software profile management module configured to store profiles in the eUICC 16 and perform operations on the profiles P stored in the eUICC 16, such module being is specifically a LPA (Local Profile Assistant) software module 15.

The LPA module 15 is a software running in the local equipment 14 and provides LPA services, such as Profile download or Profile management, to the eUICC 16. The LPA consists of two parts—the LPD (Local Profile Download) 15a and the LUI (Local User Interface) 15b. The LPD 15a plays a proxy role for the efficient download of a Bound Profile Package between SM-DP+13 and eUICC 16 (through an interface ES10b), while the LUI interface 15b allows for local profile management on the device by an end user 20, also shown in FIG. 1 which can interact with the local equipment 14 through a user interface through an ESeu interface) or with the MNO 22 through an operator interface (ESop). A Local Discovery Service (LDS) 15c is also shown as included in the LPA module 15.

In FIG. 1 are also indicated a Certificate Issuer 23, which issues Certificates for remote SIM provisioning entities and acts as a trusted third party for the purpose of authenticating the entities within the system, and an eUICC Manufacturer (EUM) 24 which is responsible for the initial cryptographic configuration and security architecture of the eUICC 16 and is the provider of eUICC products. These system components are not here described in further detail.

The system 10′ includes also a Subscription Manager-Discovery Server (SM-DS) 25 to provide mechanisms that allow an SM-DP+, like the server 13, to inform the Local Discovery Service 15c within any device that an SM-DP+ like server 13 wishes to communicate with it. A description of the operation of system 10′ can be found at the URL https://www.gsma.com/aboutus/wp-content/uploads/2015/01/FS.08_SAS-SM_Standard_v3.0.pdf.

Thus in the consumer architecture of the system 10′ the SM-DP+ server (an OTA server) contains profiles and represents the MNO. The LPA (an application on the local equipment, e.g., the phone) executes commands [load, enable . . . ] on the user equipment phone. The user changes operator, for instance, by means of the GUI (Graphic User Interface) of the LPA.

Then, the technical specification of the GSMA SGP.31 and GSMA SGP.32 standard facilitates broadening the use of such eUICCs to IoT (“Internet of Things”) devices, defining requirements and architectures to enable the remote provisioning and management of the eUICC for IoT devices in IoT devices (see, for instance, Specification SGP.31 eSIM IoT Architecture and Requirements Version 1.0 19 Apr. 2022 or Specification SGP.31 eSIM IoT Architecture and Requirements Version 1.2 26 Apr. 2024). The GSMA SGP.32 technical specification defines the overall architecture of the eUICC IoT system for IoT device (see, for instance, eSIM IoT Technical Specification, Version 1.0.1, 4 Jul. 2023).

IoT devices may be devices comprising sensors, processing ability, software and/or other technologies that can be configured to connect and exchange data with other devices and/or systems over the Internet or other communications networks, for instance, the cellular network.

The general architecture of a system for remotely provisioning and managing an eUICC for IoT devices is illustrated in FIG. 2.

FIG. 2 illustrates an IoT device 100 comprising:

an eUICC for IoT devices 102, such eUICC for IoT devices 102 comprising an ISD-R (“Issuer Security Domain-Root”) block 104 and an ISD-P (“Issuer Security Domain-Profile”) block 106 that comprises an MNO-SD (“Mobile Network Operator Security Domain”) block 108; and an IPAd (“IoT Profile Assistant in the IoT Device”) block 110 configured to serve as a proxy between the eUICC for IoT devices 102 and an eSIM IoT remote Manager, eUICC IoT manager (eIM) 112.

The eUICC for IoT devices 102, in particular, its ISD-R block 104, may be configured to be interfaced with the IPAd block 110 through:
a first IPA—eUICC interface ES10a, for performing profile download and installation operations and handling profile discovery, and
a second IPA—eUICC interface ES10b, for performing generic eUICC package download and execution.

The IPAd block 110 may be configured to be interfaced with the eIM 112 through an eIM—IPA interface ESipa, for performing profile download and installation operations, which may be used for triggering profile download at the IPAd block 110 and for providing a secure transport of the downloaded profiles to the eUICC for IoT devices 102.

The eIM 112 is a module, usually a software implemented module, for instance, a server, configured to be external to the IoT device 100 and configured to perform remote profile state management operations (PSMOs), that is, subscriptions management operations, and eIM Configuration Operations (eCOs), that is, operations for managing other eIMs, on a single IoT device or a fleet of IoT devices.

The profile state management operations may comprise for instance, sending profile state management packages to the eUICC for IoT devices 102, enable, disable, and delete profiles or to trigger profile downloads at eUICC of the IoT devices. The eIM 112 can either be a stand-alone component or a component of a higher-level functional system (e.g., device management platform).

To manage a given device, such eIM 112 may be configured to be interfaced with the eUICC for IoT devices 102 of such given device through an eIM—eUICC interface ESep, a logical end-to-end interface between eIM 112 and such eUICC for IoT devices 102 used to transfer eUICC packages for profile state management and eIM configuration data sent by the eIM 112. This eIM—eUICC interface ESep may be implemented through a communication network, e.g., a mobile or cellular communication network such as GSM, 3G such as UMTS or WCDMA, 4G such as LTE, 5G networks. The communication architecture in general comprises at least a communication network which allows communication, i.e., exchange of signals and data, with the IoT device 100 by remote servers and communication entities, For simplicity' sake is not shown explicitly in FIG. 1.

An association token generation unit 120, for instance, a global counter, may be configured to generate, if required in an ADD eIM command sent to the eUICC for IoT devices 102 by a given eIM 112, an association token AT that is associated with such given eIM 112 in order to avoid replay attacks.

The eUICC packages for profile state management may comprise a REMOTE administration command or a plurality of REMOTE administration commands, comprising commands related to eIM Configuration Operations (eCOs) and commands related to Profile State Management Operations (PSMOs).

Such REMOTE administration commands may comprise, for instance, the following types of commands:
an enable command, used to enable an installed profile in the eUICC 102, related to Profile State Management Operations;
a disable command, used to disable an enabled profile in the eUICC 102, related to Profile State Management Operations;
a delete command, used to delete an installed profile in the eUICC 102, related to Profile State Management Operations;
a list of profile information command (related to Profile State Management Operations), used by the eIM 112 to retrieve a list of profile information for installed profiles, including their current state, that is, enabled or disabled, and their associated profile metadata;
a get RAT (“Rules Authorization Table”) command, used by the eIM 112 to retrieve the Rules Authorization Table, RAT from the eUICC 102;
a configure auto-enable command, used to configure an automatic enabling of a profile in the eUICC 102, related to Profile State Management Operations.

It comprises also eIM Configuration operations (eCO) such as ADD eIM command, to add an associated eIM 112 to the eUICC 102 by providing eIM configuration data, an update eIM command, used to update eIM configuration data within the eUICC 102, a DELETE eIM command, used to delete an associated eIM 112 from the eUICC 102; and/or a list eIM command, used by the eIM 112 to request the eUICC 102 to provide a list of currently configured associated eIMs. Therefore, the eIM 112 may be further configured to manage a list of eIMs on an eUICC, that is, to perform eCO.

Such eIM 112 is further configured to communicate with:
a SM-DP+ (“Subscription Manager Data Preparation+”) block 114, a server configured to prepare, store, and deliver digital eSIM profiles based on information obtained from an operator 116, e.g., an MNO (Mobile Network Operator), through an operator—SM-DP+ interface ES2+, such operator—SM-DP+ interface ES2+ being used by the operator to request the preparation of a profile for one or more eUICCs for IoT devices 102 and for other administrative functions, and
a SM-DS (“Subscription Manager Discovery Server”) block 118, which is a server configured to hold a list of the profiles that are available to each of the considered devices.

The communication between the eIM 112 and the SM-DP+ block 114 may be implemented through an eIM—SM-DP+ interface ES9+′, used for profile download and installation.

The communication between the eIM 112 and the SM-DS block 118 may be implemented through an eIM—SM-DS interface ES11′, used to retrieve records of the events between such eIM 112 and such SM-DS block 118.

In addition, such SM-DP+ block 114 may be configured to be interfaced with the SM-DS block 118 through an SM-DS—SM-SP+ interface ES12, used by the SM-DP+ block 114 to manage event registrations and event deletions on the SM-DS block 118.

The MNO-SD block 108 may be configured to be interfaced with the operator 116 through an operator—eUICC interface ES6, used by the operator in order to manage their profiles stored within the eUICC for IoT devices 102 via OTA (“Over-The-Air”) services.

The IPAd block 110 may be further configured to be interfaced with the SM-DP+ block 114 through an IPA—SM-DP+ interface ES9+, used for providing a secure transport of profile packages between the SM-DP+ block 114 and the IPAd block 110, for instance, using an HTTPS (“HyperText Transfer Protocol Secure”) protocol in server authentication mode to communicate.

In addition, such IPAd block 110 may be further configured to be interfaced with the SM-DS block 118 through an IPA—SM-DS interface ES11, used to retrieve records of events between such IPAd block 110 and such SM-DS block 118 and being secured by TLS (“Transport Layer Security”) in server authentication mode.

The eUICC for IoT devices 102 may be further configured to be interfaced with the SM-DP+ block 114 through an SM-DP+—eUICC interface ES8+ configured to couple the ISD-P block 106 of the eUICC for IoT devices 102 with the SM-DP+ block 114 to provide a secure end-to-end channel between them for the administration of such ISD-P block 106 and the associated profiles during download and installation operations.

Such coupling provided by such SM-DP+—eUICC interface ES8+ may be intended to be tunneled either over the IPA—SM-DP+ interface ES9+ and the second IPA—eUICC interface ES10b for a direct profile download, in which the IPAd block 110 can directly communicate with the SM-DP+ block 114, or the eIM—SM-DP+ interface ES9+′, the eIM—IPA interface ESipa, and the second IPA—eUICC interface ES10b for an indirect profile download, in which the IPAd block 110 communicates with the SM-DP+ block 114 via the eIM 112.

In the general architecture described in FIG. 2, such eUICC for IoT devices 102 is to be associated with at least one eIM 112 before being able to do any profile state management operations, i.e., an eIM whose eIM Configuration Data is available within the eUICC and used by the eUICC for verification of an eIM configuration operation or PSMO is in a specific relationship with an eUICC. Such Configuration Data are used by the eUICC for verification of an eIM Configuration Operation or PSMO, as for instance defined in the Specification SGP.31 eSIM IoT Architecture and Requirements Version 1.0 19 Apr. 2022.

It is underlined that, with respect to the architecture shown in FIG. 1, a system for remotely provisioning and managing an eUICC for IoT devices may have also an IoT Profile Assistant in the eUICC IPAe, IoT Profile Assistant in the eUICC, (this being also described in the GSMA SGP.32 specification) instead of an IoT Profile Assistant in the IoT Device IPAd, 110 in FIG. 2.

The ISD-R block 104 comprised in the eUICC for IoT devices 102 may be configured to be interfaced with the eIM 112 via the IPAe, for instance, also here through the eIM—IPA interface ESipa used to perform profile download and installation operations and the eIM—eUICC interface ESep, triggering profile download at the IPAe and providing a secure transport of the downloaded profiles to the eUICC for IoT devices 102. Also the IPAe may be further interfaced with the SM-DP+ block 114 through the IPA—SM-DP+ interface ES9+, providing a secure transport of profile packages between the SM-DP+ block 114 and the IPAe, for instance, using an HTTPS (“HyperText Transfer Protocol Secure”) protocol in server authentication mode to communicate. In addition, such IPAe may be interfaced with the SM-DS block 118 through the IPA—SM-DS interface ES11, to retrieve records of events between such IPAe and such SM-DS block.

It is noted that same conclusions related to an association performed via the IPAd block 110 described above are also valid for associations performed via the IPAe, thus, for instance, an ADD Initial eIM command send by the IPAe to the eUICC for IoT devices 102 shall not comprise a signature.

Under the framework of specification GSMA SGP.31, SGP.32 eSIM for IoT and GSMA SGP.21, SGP.22, a notification is a report about a Profile download, Local/remote Profile Management Operation or Remote eUICC Management operation processed by the eUICC or about the progress of such an operation.

A eUICC Package Result is a cryptographically signed package prepared by the eUICC that contains the execution result of the eUICC Package. The eUICC Package Result is available in the eUICC IoT (SGP.32).

The eUICC Package is then a cryptographically signed package prepared by the eIM that contains either PSMO(s) or eCO(s). The package is verified and executed by the eUICC. Thus the eUICC Package Result can be defined as a report on the execution of eUICC packages for profile state management.

The eIM sends commands to the eUICC these commands reach the device using some kind of connectivity, reach the IPA that then forwards them to the eSIM.

The eUICC, or eSIM, can send notifications to different servers, but the actual retrieval and forwarding is managed by the LPA/IPA, as described above. The eUICC, or eSIM, and eIM communicate through the LPA (Local Profile Assistant) or IPA (IoT Profile Assistant) respectively. Also, as described with reference to FIGS. 1 and 2, in general the LPA/IPA receives the profile from the server and downloads it on the eUICC.

The eUICC generates a notification for each server configurated.

At the Consumer, e.g., in the architecture of FIG. 1, in case of a Profile management operation (enable, disable, delete), for each server configurated the eUICC generates a Notification.

Thus, with reference to FIG. 3A, where schematically it is shown architecture after the one in FIG. 1, the SM-DP+13 and the LPA 15 enact Perform management operations on profiles PA, PB and corresponding notifications NF1, NF2 are stored in the eUICC 16.

At the IoT, e.g., in the architecture of FIG. 2, in case of a Profile management operation (enable, disable, delete), the eUICC generates a notification for each server configured and for the EIM an eUICC Package Response.

Thus, with reference to FIG. 3B, where schematically it is shown architecture after the one in FIG. 2, the eIM 112 and the IPAd 110 enact Perform management operations on profiles PA, PB and corresponding notifications NF1, NF2 and eUICC Package Results RPK1, RPK2 re are stored in the eUICC 102.

For each profile operation (download, enable, disable and delete) a network notification is generated on card. The LPA\IPA is in charge to remove the notifications from the card storage, in particular after they have been sent to the server as specified in the standard. However, this rule is not strictly followed by all LPA/IPA implementation on the market.

To delete the entire set of notifications stored on card, the LPA/IPA should remove the notifications one by one, issuing different commands and using the sequence number to identify them, as specified in the standard.

This operation requires the LPA/IPA to know the sequence number, therefore a retrieve notification command is needed first.

Also the LPA/IPA needs to check the notifications content to distinguish between download, delete, disable, and enable profile operations.

The amount of data exchanged between the terminal and the card can be huge, causing large delays and impacting the user experience.

The LPA/IPA could keep on card the stored notifications due to the fact that the notification server is not available anymore.

Thus, the solution currently known is based on the GSMA specification, GSMA SGP.22/SGP.32, which to limit the number of notifications, recommends that the LPA or IPA shall remove notifications after they have been retrieved.

Then, also some LPA/IPA implementations do not respect the specification recommendation and do not remove notifications.

### SUMMARY

An object of one or more embodiments is to contribute in providing solutions that facilitate deletion of the notifications stored in the eUICC, in particular reducing effort and simplify notifications management by the LPA/IPA in those situations with many notifications pending.

According to one or more embodiments, that object is achieved via an embedded Universal Integrated Circuit Card having the features set forth in the claims that follow.

One or more embodiments concern a related method.

One or more embodiments concern a related system architecture.

One or more embodiments concern a managing method of the embedded Universal Integrated Circuit Card.

One or more embodiments concern a communication protocol.

One or more embodiments may refer to a corresponding processing device or computer performing the method and to a computer program product that can be loaded into the memory of at least one computer and comprises parts of software code that are able to execute the steps of the method when the product is run on at least one computer. As used herein, reference to such a computer program product is understood as being equivalent to reference to a computer-readable means containing instructions for controlling the processing system in order to co-ordinate implementation of the method according to the embodiments. Reference to “at least one computer” is evidently intended to highlight the possibility of the present embodiments being implemented in modular and/or distributed form. The claims are an integral part of the technical teaching provided in respect of the embodiments.

Solutions as described herein include an embedded Universal Integrated Circuit Card configured to store notifications generated upon a profile operation execution in the eUICC, and comprising a non-volatile memory storing instructions and a module or processor configured to execute the instructions to manage the notifications in the eUICC, remove one or more notifications upon receiving a removing command, the removing command is configured to command removal of selected notifications stored in the eUICC, the selection of the notifications being determined through a selection argument of the removing command, the selection of the notifications which can be determined through the selection argument comprising selecting all the notifications stored in the eUICC for deletion.

In variant embodiments, the removing command is configured to operate with a selection argument represented by a data object comprising one or more selection criterion of the notifications which indicates which notifications are selected for deletion, the module being configured to remove all the notifications if the removing command does not include the data object comprising one or more selection criterion of the notifications.

In variant embodiments, the module is configured to remove all the notifications if a parameter of the data object comprising one or more selection criterion of the notifications is equal to a given value.

In variant embodiments, the eUICC is an eSIM for IoT operating according to the specification SGP.32.

In variant embodiments, the eUICC is configured to receive the notifications removing command over an interface between the eUICC and a profile assistant module, in particular an ES10b interface.

In variant embodiments, the removing command is configured to delete also all the reports on the execution of eUICC packages for profile state management, in particular eUICC Package results according to specification SGP.32, stored in the eUICC.

In variant embodiments, the module configured to remove the notifications from the eUICC is an ISD-R of the eUICC.

In variant embodiments, the selection argument comprises a parameter represented by a sequence number, which indicates to remove a Notification or reports on the execution of eUICC packages for profile state management which has a corresponding sequence number value in a list of stored notifications.

In variant embodiments, the eUICC is configured to mark further comprising marking as read at the eUICC notifications and reports read by a respective recipient entity, and upon receival of the notifications removing command, associated to a selection of the notifications determined through the selection argument indicating selecting all the notifications stored in the eUICC for deletion, deleting only the marked notifications.

The solution here described refers also to a system architecture, comprising: an embedded Universal Integrated Circuit Card, eUICC, according to embodiments, and comprising a remote provisioning server, in particular a SM-DP+, or a remote manager module, in particular an eIM, configured to communicate with a profile assistant module to perform profile state management operation on profiles of the eUICC.

The solution here described refers also to a method for managing an embedded Universal Integrated Circuit Card, eUICC, in which are stored notifications (generated upon a profile operation execution in the eUICC, the method comprising managing the notifications at the eUICC, the managing comprising removing one or more notifications (upon receiving a removing command, comprising removing the notifications from the eUICC upon receiving the removing command, the removing command commanding removal of selected notifications stored in the eUICC, the selection of the notifications being determined through a selection argument of the removing command, the selection of the notifications which can be determined through the selection argument comprising selecting all the notifications (stored in the eUICC for deletion.

In variant embodiments, the selection argument is represented by a data object comprising one or more selection criterion of the notifications which indicates which notifications are selected for deletion, removing all the notifications if the removing command does not include the data object comprising one or more selection criterion of the notifications.

In variant embodiments, comprising removing all the notifications if a parameter of the data object comprising one or more selection criterion of the notifications is equal to a given value.

In variant embodiments, the eUICC is an eSIM for IoT operating according to the specification SGP.32 and the removing command is configured to delete also all the reports on the execution of eUICC packages for profile state management, in particular eUICC Package results according to specification SGP.32, stored in the eUICC.

In variant embodiments, the selection argument comprises a parameter represented by a sequence number, which indicates to remove a Notification or reports on the execution of eUICC packages for profile state management which has a corresponding sequence number value in a list of stored notifications.

In variant embodiments, the method further comprises marking as read at the eUICC notifications and reports read by a respective recipient entity, and upon receival of the notifications removing command deleting only the marked notifications.

In variant embodiments, the method comprises upon receival of the notifications removing command selecting a notification or report and to check if it matches the one or more selection criterion, in the positive performing a further check if it is marked as already retrieved, after which, if it is negative it is checked if there is any notification or report left stored in the eUICC, in the positive selecting a next notification among those left stored in the eUICC to perform the check if it matches the one or more selection criterion, while if the further check is positive, it is performed the deletion of such notification or report and the check if there is any notification or report left stored in the eUICC.

The solution here described refers also to a communication protocol of a system architecture according to SGP.22 or SGP.32, comprising:
an embedded Universal Integrated Circuit Card, eUICC, and
a remote provisioning server, in particular a SM-DP+, or a remote manager module, in particular an eIM, configured to communicate with a profile assistant module to perform profile state management operation on profiles of the eUICC, the communication protocol comprising a command for removing notifications from the embedded Universal Integrated Circuit Card, eUICC, wherein the removing command is configured to command removal of selected notifications stored in the eUICC, the selection of the notifications being determined through a selection argument of the removing command, the selection of the notifications which can be determined through the selection argument comprising selecting all the notifications (stored in the eUICC for deletion.

The solution here described refers also to a computer program product that can be loaded into the memory of at least one computer and comprises parts of software code that are able to execute the steps of the method of any of embodiments when the product is run on at least one computer.

### BRIEF DESCRIPTION OF THE DRAWINGS

One or more embodiments will now be described, by way of example only, with reference to the annexed figures, wherein:

FIG. 1 illustrates a schematic representation of a system for managing profiles in consumer eUICC cards;

FIG. 2 illustrates a general architecture of a system for remotely provisioning and managing an eUICC for IoT devices;

FIG. 3A illustrates architecture of the FIG. 1 type in which the SM-DP+13 and the LPA 15 enact Perform management operations on profiles PA, PB;

FIG. 3B illustrates architecture of the FIG. 2 type in which eIM 112 and LPA 100 enact Perform management operations on profiles PA, PB; and

FIG. 4 illustrates a flow diagram regarding an embodiment of the method herein described.

Corresponding numerals and symbols in the different figures generally refer to corresponding parts unless otherwise indicated.

The figures are drawn to clearly illustrate the relevant aspects of the embodiments and are not necessarily drawn to scale.

The edges of features drawn in the figures do not necessarily indicate the termination of the extent of the feature.

### DETAILED DESCRIPTION OF ILLUSTRATIVE EMBODIMENTS

In the ensuing description one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment.

Moreover, particular configurations, structures, or characteristics may be combined in any adequate way in one or more embodiments.

The headings/references used herein are provided merely for convenience and hence do not define the extent of protection or the scope of the embodiments.

For simplicity and ease of explanation, throughout this description, and unless the context indicates otherwise, like parts or elements are indicated in the various figures with like reference signs, and a corresponding description will not be repeated for each and every figure.

The solution here described refers to an integrated circuit card, in particular eUICC, and a method for managing an integrated circuit card, comprising a notifications removing command to delete notifications, which may be sent e.g., from the IPA or LPA, and it is added to the ISD-R application of the card. Such notifications removing command, indicated for instance here as “DeleteNotifications” extends the capabilities of the SGP.32/SGP.22 standard ES10b.RemoveNotification command.

Thus, with reference to the specification SGP.32, eSIM IoT Technical Specification Version 1.1 26 Apr. 2024, context, the notifications removing command “DeleteNotificationRequest”, also indicated in the following as notifications removing command DNR, may be structured as described in the example ‘Removing command DNR’ below by the ASN.1 (Abstract Syntax Notation One) language, which is used in SGP.32 to describe the commands.
‘Removing command DNR’
—ASN1START
DeleteNotificationsRequest::=SEQUENCE{
searchCriteria CHOICE {
seqNumber [0] INTEGER,
profileManagementOperation [1] NotificationEvent,
euiccPackageResults [2] NULL
} OPTIONAL
}
—ASN1STOP

In embodiments, the name of the ES10b command may be also “DeleteNotificationsList” and the ASN.1 name “DeleteNotificationsListRequest” for symmetry with respect to “RetrieveNotificationsList” and “RetrieveNotificationsListRequest” in the specification.

Thus, the notifications removing command DNR according to the solution here described is a command provided by the ISD-R, i.e., the ISD-R 104 block as its provider entity, e.g., within the meaning of SGP.22 or SGP.32, which like the RemoveNotifications command provided by the specification SGP.32 may be related to the Profile Download and Installation and/or, Generic eUICC Package Download and Execution.

As shown above, a selection argument of the notifications removing command DNR is represented by the data object searchCriteria used to filter the list of Notifications or eUICC Package Results that the eUICC 100 removes. Thus if the data object Searchcriteria is omitted, i.e., not included with or associated to the removing command DNR, there is no filtering of the list of Notifications or eUICC Package Results that the eUICC 100 removes, i.e., all the Notifications or eUICC Package results are removed. Analogously, the “RetrieveNotificationsListRequest” list all the notifications if the data object Searchcriteria is omitted.

The data object Searchcriteria is then structured in the same way as for the command RetrieveNotifications List request, including the same three parameter, i.e.;
a first parameter, i.e., a sequence number data object SeqNumber, which indicates to the eUICC to remove a Notification or an eUICC Package Result that has the sequence number value corresponding to the one indicated in the sequence number data object SeqNumber;
a second parameter is represented by profileManagementOperation, where A bit set to 1 in the profileManagementOperation in general in SGP.32 indicates that the eUICC shall return all the Notifications corresponding to this type. Thus, also The notifications removing command DNR may be structured as in the previous example in ASN.1 language, so that a bit set to a given logic value, namely logic one, in the profileManagementOperation indicates that the eUICC 100 removes all the Notifications and eUICC Package Results corresponding to this type, i.e., the type, a property referring to the class of the notifications (e.g., only enable profile notifications), in profileManagementOperation identified by the bit set to logic one. The type notificationInstall include ProfileInstallationResults;
a third parameter, a eUICC Package Results deletion parameter euiccPackageResults which indicates that the eUICC 100 deletes all the eUICC Package Results.

As for the implementation in the procedures of the specifications SGP.22 and SGP. 32 the notifications removing command DNR here described may be used in substitution of the Removenotifications command where is indicated in such specifications, since the first, second and third parameter can be set to perform the same uses.

By way of example an omission of the data object searchCriteria, in ASN.1 can be implemented as in the following ASN.1 example:
value DeleteNotificationsRequest::={
}
i.e. omission means that the data object searchCriteria is not included in the arguments of DeleteNotificationsRequest.

Although, this implementation with the omission of the searchCriteria exploits the nature of the command, designed in analogy to RetrieveNotificationsListRequest, i.e., the fact that requires a filter criterion to filter the notification to delete, otherwise all the notifications are selected, it is possible in variant embodiments, to maintain the data object searchCriteria and set a specific value inside such data object searchCriteria which is uniquely recognized as dictating that all Notifications and/or reports are deleted. By way of example, this can be done exploiting a specific value of one of the parameters which is not already assigned to an action, for instance the sequence number data object seqNumber can be set to a negative value, such as minus one.

In the following is supplied a simplified example of the command DNr with the seqNumber set to −1:
value DeleteNotificationsRequest::={
searchCriteria seqNumber:−1
}

Additionally, a mechanism to prevent the deletion of the unread Notifications and unread eUICC Package Results can be adapted.

By way of example, when a Notification is read by the LPA\IPA by using the ES10b.RetrievedNotification command, the method provides that the notification or eUICC Package Result is marked as ‘read’. When the DeleteNotifications command is sent to the card the method provides that only the Notifications marked as ‘read’ will be deleted.

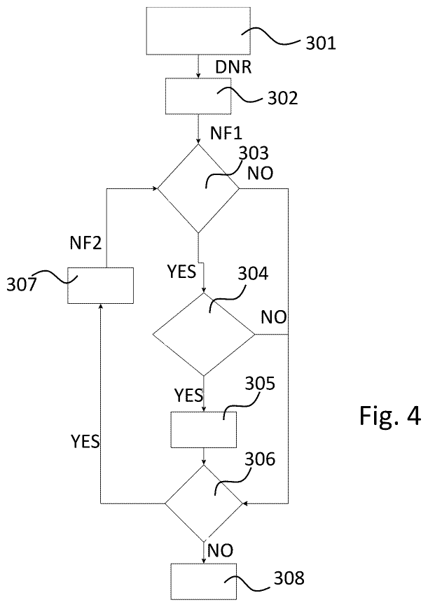

This exemplified in the diagram of FIG. 4, describing an implementation 300 of the method with the mechanism to prevent the deletion of the unread Notifications.

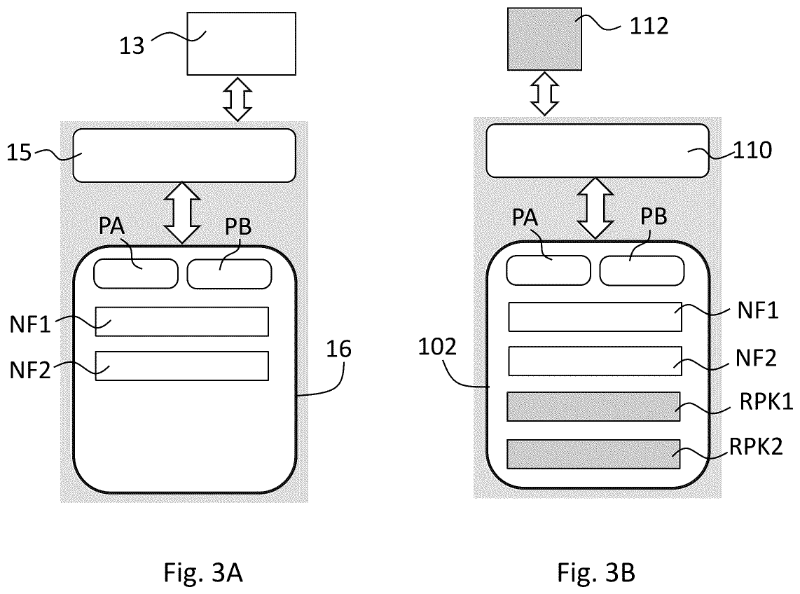

Thus, with 301 is indicated the receival of the notifications removing command DNR from the IPA 110 to the ISD-R 104. The notifications removing command DNR is configured by at least its first input parameter, or argument, the data object searchCriteria, specifying which Notifications and Package Results are to be deleted. In a step 302 it is performed a selection of a first notification, e.g., NF1, in the eUICC 102. In a verification step 303 is checked if the selected notification, NF1, matches the selection criterion, i.e., the data object searchCriteria. In the positive, i.e., it is a notification to be deleted, a further verification step 304 is performed to check if the notification NF1 is marked as already retrieved. In the negative, control passes to a verification step 306 which checks if there is any notification left stored in the eUICC 102. In the positive, with reference to FIG. 3 for instance NF2, a step 307 of selecting a next notification, NF2, among those left stored in the eUICC 102 is performed and the control passes again to the verification step 303.

If the verification step 304 has a positive outcome, indicating that the notification NF1 is marked as already retrieved, it is performed in a step 305 the deletion of such notification, then the verification step 306 which checks if there is any notification left stored in the eUICC 102 is performed.

The method described in the FIG. 4 comprises marking the read notifications and reports as retrieved, or read, prior the execution of the procedure 300. The marking can be performed on the Pending Notification List in the eUICC, e.g., or using flags to the notification indicating the notification as retrieved.

The method here described in embodiments may also provide that the eIM 112 is configured to send a command to the IPA 110 to delete all the notifications stored in the card, e.g., eUICC 102. This can be useful for example if a profile download is initiated, and it fails because there is no available space.

The eIM 112 may be configured to delete the stored notifications to free a portion of space before trying the profile download again.

The notifications removing command DNR may be therefore issued without data in the first input parameter to this purpose. As mentioned the notifications removing command DNR can be used in place of the Removenotifications command where required by the specification SGP. 32, setting the input parameter in line with the requirements of the specific use, in particular with the same input parameters, as the different behavior takes place when the first input parameter, the data object searchCriteria, is left void.

Also, in general, the notifications removing command DNR, e.g., “DeleteNotificationRequest” or “DeleteNotificationListRequest” may be called by applications, whenever deemed necessary, depending on the notification removal policy of the specific LPA/IPA implementation. As mentioned, although specifications SPG.22/.32 would dictate deleting the notification after retrieval, this is not always followed, thus notification can be left stored in the card, and a notifications removing command DNR can be commanded, for instance periodically, or upon the occurrence of specific events/conditions.

Thus, the notifications removing command DNR is used by the IPA. The conditions to trigger the usage of this command could be for example the following: after a retrieveNotificationsList command, the eUICC replies with a great amount of notifications. Instead of manually deleting them one at a time, the IPA can send our command to delete.

For instance an IPA 110 (or LPA 15) may send a command, RetrieveNotificationsList, which is known per se in the SGP specifications, to the eUICC 102, which responds with a response, RetrieveNotificationsListResponse which comprises in this example five Notifications. This number of Notifications is higher of a given threshold, e.g., 4 Notifications, thus at the IPA 110 such response, RetrieveNotificationsListResponse triggers sending DeleteNotificationListRequest, i.e., the notifications removing command DNR to the eUICC 102. The eUICC 102 may respond with a single NotificationSentResponse command, a command already present in the SGP specifications for responding to RemoveNotificationFromList commands, with argument ok (o), i.e., omission of searchCriteria which indicates the deletion, in this case of all the Notifications reported by the response, RetrieveNotificationsListResponse. Clearly, in the case the response, RetrieveNotificationsListResponse, indicates a number of Notifications lower or equal than the threshold, the IPA 112 may provide deletion of the Notifications one by one, with the RemoveNotificationFromList command applied to each Notification with its respective Sequence Number. The eUICC 102 each time receives the RemoveNotificationFromList command responds with a respective NotificationSentResponse command with argument ok (o).

It is underlined here, also with reference to the diagram flow of FIG. 4, that the removing command DNR according to the solution is usually preceded by the retrieval of a list of the notifications stored in the eUICC, for instance, 102, for instance by the command RetrieveNotificationsList. Then the removing command DNR is of a form with a name of the command, e.g., DeleteNotifications, which syntax include evaluation of a selection argument, specifically the data object searchCriteria. As explained, if such evaluation of the selection argument searchCriteria gives that the selection argument, in particular data object, searchCriteria, is omitted, then all the Notification (with the possible addition of Reports in SGP.32) are deleted. However, the introduction of a deletion or removing command, i.e., DNR, which a selection argument, such as searchCriteria, can be exploited also to delete a subset of stored notifications or specific notifications, using the presence of a selection argument, which parameters allow that, i.e., selecting on the base of sequence number, or also of the type of notification, based on the list from the command RetrieveNotificationsList. Then, the introduction of a deletion command with a selection argument, allows to also to obtain removal of all notifications, by giving to a parameter of the selection argument, which is not assigned to the selection functions from the notifications list from the command RetrieveNotificationsList.

Thus in general the solution here described refers to an embedded Universal Integrated Circuit Card, eUICC, e.g., 16 for consumer cards or 102 for IoT eSIM, configured to store notifications, e.g., NF1, NF2 in consumer cards or NF1, NF2, PK1, PK2, i.e., including also eUICC Package results, for IoT eSIM, generated, in particular for being sent to entities, such as SM-DP+13 or eIM 112, in particular remote servers, upon a profile operation execution in such eUICC, and comprising a module, e.g., the ISD-R block 104, configured to manage such notifications, here notifications referring to only notifications or also including eUICC Package results in IoT eSIM from the eUICC, in particular after they have been sent, such module, e.g., 104, being configured to remove one or more notifications upon receiving a removing command, wherein the module, e.g., 104, configured to manage the notifications, e.g., NF1, NF2; NF1, NF2, PK1, PK2, in the eUICC, e.g., 16 or 102, being configured to remove such notifications from the eUICC, e.g., 16 or 102, upon receiving the removing command, e.g., the command indicated with DNR and described in the corresponding ASN.1 syntax of DeleteNotifications, such removing command, e.g., command DNR or DeleteNotifications, being configured to command removal of selected notifications, stored in the eUICC, e.g., 16 or 102, the selection of the notifications being determined through a selection argument, which is for instance searchCriteria, of such removing command, e.g., command DNR or

DeleteNotifications, the selection of the notifications which can be determined through the selection argument, e.g., searchCriteria, comprising selecting all the notifications, e.g., NF1, NF2; NF1, NF2, PK1, PK2, stored in such eUICC, 16 or 102, for deletion.

Thus, the selection of the notifications is determined through a selection argument not including, i.e., omitting the selection argument, i.e., searchCriteria, from the removing command DNR or assigning a given value which indicates deletion of all notifications.

More specifically, in embodiments, the removing command, e.g., command DNR or DeleteNotifications, is configured to operate with a selection argument represented by a data object comprising one or more selection criterion, e.g., searchCriteria, of the notifications which indicates which notifications are selected for deletion, the module, e.g., 104 in the eUICC, being configured to remove all the notifications if the removing command, e.g., command DNR or DeleteNotifications, does not include the data object comprising one or more selection criterion, in particular searchCriteria, of the notifications. As with the selection argument, which the removing command DNR or Deletenotification admits as element specifying the object of its removing actions, is used by omission of the same argument when issuing the command removing command DNR or Deletenotification.

Then in variant embodiments, the removing command, e.g., command DNR or DeleteNotifications, is configured to operate with a selection argument represented by a data object comprising one or more selection criterion, and the module 104 is configured to remove all the notifications e.g., NF1, NF2; NF1, NF2, PK1, PK2, if a parameter of the data object, e.g., searchCriteria, of the notifications is equal to a given value, in the example SeqNumber=−1, which is a value not used to select one of the notifications stored, e.g., with the sequence number specified by RetrieveNotificationsList, or a subset of stored notifications, e.g., based on the type.

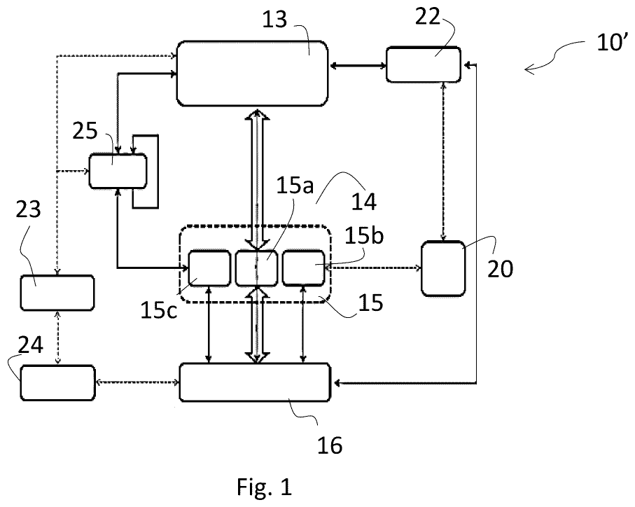

As mentioned, the eUICC, e.g., 102, may be an eSIM for IoT operating according to the specification SGP.32. Alternatively, as said, it may be an eUICC operating in an architecture like in FIG. 1.

In particular, the eUICC 102 may be configured to receive the notifications removing command. e.g., DNR, over an interface between the eUICC and a profile assistant module, e.g., LPA 15 or 110, in particular an ES10b interface in case of SGP.32.

As mentioned above, in case of eSIM for IoT, the removing command, e.g., DNR, is configured to delete also all the reports on the execution of eUICC packages for profile state management, e.g., PK1, PK2, in particular eUICC Package results according to specification SGP.32, stored in the eUICC, e.g., 102. Thus, in the eSIM for IoT the removing command DNR can cancel both notifications and reports, i.e. reports on the execution of eUICC packages for profile state management, at once in the same time.

As mentioned, the module, e.g., 104, configured to remove the notifications from the eUICC, e.g., 16 or 102, is configured to filter a list of Notifications, e.g., NF1, NF2, and the reports on the execution of eUICC packages for profile state management, e.g., PK1, PK2, on the basis of the content of the one or more search criteria, e.g., specifying the sequence number or the type. This means that inputting data in such data object searchCriteria, specific notifications and reports can be deleted, without deleting all the stored notifications and reports.

Thus, for instance the selection argument, e.g., searchCriteria, comprises a parameter represented by a sequence number, e.g., SeqNumber, which indicates to remove a Notification, e.g., NF1, NF2 or reports on the execution of eUICC packages for profile state management, e.g., PK1, PK2, which has a corresponding sequence number value in a list of stored notifications.

Further, with reference to FIG. 4, the eUICC e.g., 16 or 102, may be configured to mark, e.g., step 301 of FIG. 4, as read, or retrieved, at the eUICC, notifications and reports read by a respective recipient entity, e.g., a server, and upon receival of the notifications removing command, e.g., DNR, associated to a selection of the notifications determined through the selection argument, searchCriteria, indicating selecting all the notifications stored in such eUICC, 16 or 102, for deletion, deleting, as for instance in step 306, only the marked notifications.

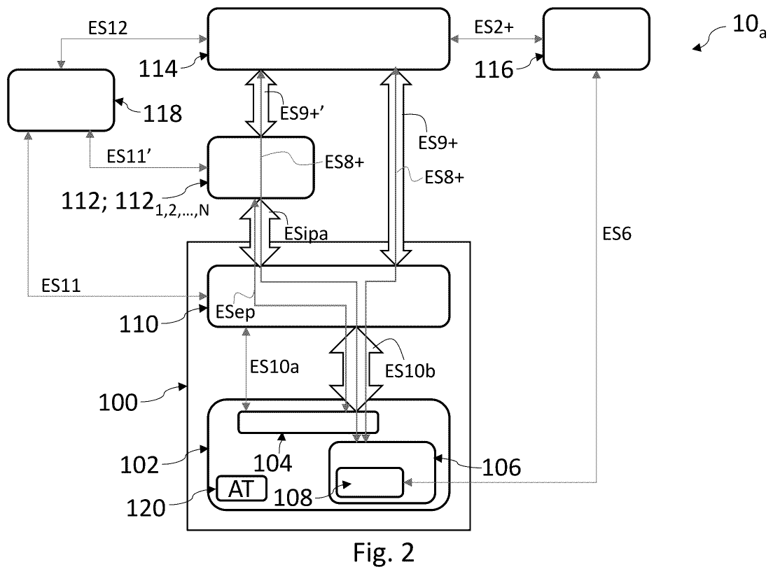

The solution also extends to a system architecture, e.g., 10 like in FIG. 1 or 10a like in FIG. 2, comprising:
an embedded Universal Integrated Circuit Card, eUICC, e.g., 16 or 102, as just described in the above embodiments, i.e. including the removing command DNR,
and comprising a remote provisioning server, e.g., in particular a SM-DP+13, or a remote manager module, e.g., an eIM 112, configured to communicate with a profile assistant module, e.g., LPA 15 or IPAd 110, to perform profile state management operation on profiles, such as profiles PA, PB, of the eUICC, e.g., 16 or 102.

In the architecture 10a for instance the remote manager module, in particular eIM 112, may be configured to request to the eUICC 102 to perform the removing command DNR without inputting a selection argument, e.g., searchCriteria, to delete all the notifications or reports in the eUICC.

Clearly the solution refers also to a corresponding method for managing an embedded Universal Integrated Circuit Card, eUICC, in which are stored notifications, e.g., NF1, NF2; NF1, NF2, PK1, PK2, in particular generated for being sent to entities, e.g., 13, 112, in particular remote servers, when a profile operation is performed in the eUICC, e.g., 16; 102, in the eUICC and comprising removing the notifications, e.g., NF1, NF2; NF1, NF2, PK1, PK2, from the eUICC, upon receiving a removing command, comprising removing the notifications, e.g., NF1, NF2; NF1, NF2, PK1, PK2, from the eUICC, e.g., 16 or 102, upon receiving the removing command, e.g., DNR, in particular from the profile assistant, e.g., 110, the removing command, DNR, commanding removal of selected notifications, NF1, NF2; NF1, NF2, PK1, PK2, stored in the eUICC, e.g., 16 or 102, the selection of the notifications being determined through a selection argument, e.g., searchCriteria, of the removing command, DNR, the selection of the notifications which can be determined through the selection argument, searchCriteria, comprising selecting all the notifications, e.g., NF1, NF2; NF1, NF2, PK1, PK2, stored in the eUICC, e.g., 16 or 102, for deletion. As explained, selected notifications means also all the notifications which are selected either by omitting the selection argument searchCriteria or by indicating a specific value in a parameter of such selection argument searchCriteria, e.g., SeqNumber=1.

It is underlined that is described here also a communication protocol of a system architecture, such as 10 or 10a, according to SGP.22 or SGP.32, comprising:
an embedded Universal Integrated Circuit Card, eUICC, e.g., 16 or 102, as just described in the above embodiments, i.e. including the removing command DNR,
and comprising a remote provisioning server, e.g., in particular a SM-DP+13, or a remote manager module, e.g., an eIM 112, configured to communicate with a profile assistant module, e.g., LPA 15 or IPAd 110, to perform profile state management operation on profiles, such as profiles PA, PB, of the eUICC, e.g., 16 or 102.

The communication protocol according to SGP.21 or SGP.32 comprises also, for instance in substitution or in parallel with the RemoveNotifications command, a command for removing notifications from the embedded Universal Integrated Circuit Card, eUICC, e.g., 16 or 102, wherein the removing command, e.g., DNR, which may also be denominated as DeleteNotifications or DeleteNotificationsList, is configured to command removal of selected notifications, e.g., NF1, NF2; NF1, NF2, PK1, PK2, stored in the eUICC, the selection of the notifications being determined through a selection argument, searchCriteria, of the removing command, e.g., DNR, the selection of the notifications which can be determined through the selection argument, searchCriteria, comprising selecting all the notifications, e.g., NF1, NF2; NF1, NF2, PK1, PK2, stored in the eUICC, 16, 102, for deletion.

Also the solution refers to a computer program product directly loadable into the internal memory of at least a digital computer, which can be seen as the profile assistant 110 and ISD-R 104, comprising software code portions for performing the method indicated above.

Thus, based on the above description the advantages of the solution here described are clear.

A retrieveNotifications command with a great number of notifications stored, would cause the eUICC to output a great amount of data. This might require many back and forth Get Response commands between the eUICC/eSIM and the LPA/IPA and would take a great amount of time to be processed.

The solution described greatly reduces such overhead by providing a removing command with a notification selection argument, which allows also to delete all the notifications (and possibly also reports) with a single removing command. Advantageously, with the method here disclosed the amount of data exchanged between the LPA/IPA and eUICC is reduced.

Also, the software implementation for deleting all the notifications and Package results is simpler.

Without prejudice to the underlying principles, the details and the embodiments may vary, even significantly, with respect to what has been described by way of example only without departing from the scope of the embodiments.

The extent of protection is determined by the annexed claims.

What is claimed is:

1. An embedded Universal Integrated Circuit Card (eUICC) configured to store notifications generated upon a profile operation execution in the eUICC, and comprising:
a non-volatile memory storing instructions; and
a processor coupled to the memory and configured to execute the instructions to:
manage the notifications in the eUICC; and
remove one or more notifications upon receiving a removing command, the removing command configured to command removal of selected notifications stored in the eUICC, a selection of the selected notifications determined through a selection argument of the removing command, the selection argument comprising selecting all notifications stored in the eUICC for deletion.

2. The eUICC according to claim 1, wherein the removing command is configured to operate with the selection argument represented by a data object comprising one or more selection criterion of the notifications that indicates which notifications are selected for deletion, the processor being configured to execute the instructions to remove all the notifications in response to the removing command not including the data object comprising the one or more selection criterion of the notifications.

3. The eUICC according to claim 1, wherein the removing command is configured to operate with the selection argument represented by a data object comprising one or more selection criterion of the notifications that indicates which notifications are selected for deletion, the processor configured to execute the instructions to remove all the notifications in response to a parameter of the data object comprising the one or more selection criterion of the notifications being equal to a given value.

4. The eUICC according to claim 1, wherein the eUICC is an embedded subscriber identity module (eSIM) for Internet of Things (IoT) operating according to Specification Group Profile (SGP).32.

5. The eUICC according to claim 4, wherein the eUICC is configured to receive the removing command over an interface between the eUICC and a profile assistant module.

6. The eUICC according to claim 4, wherein the removing command is further configured to delete all reports on an execution of eUICC packages for profile state management stored in the eUICC.

7. The eUICC according to claim 1, wherein the processor is configured to implement an issuer security domain-root (ISD-R) to execute the instructions to remove the notifications.

8. The eUICC according to claim 1, wherein the selection argument comprises a parameter represented by a sequence number, which indicates to remove a notification or reports on an execution of eUICC packages for profile state management that has a corresponding sequence number value in a list of stored notifications.

9. The eUICC according to claim 1, wherein the eUICC is configured to mark as read at the eUICC notifications and reports read by a respective recipient entity, and upon receival of the removing command, associated to the selection of the notifications determined through the selection argument indicating selecting all the notifications stored in the eUICC for deletion, deleting only marked notifications.

10. A system architecture, comprising:
an embedded Universal Integrated Circuit Card (eUICC) configured to store notifications generated upon a profile operation execution in the eUICC, and comprising:
a non-volatile memory storing instructions; and
a processor coupled to the memory and configured to execute the instructions to:
manage the notifications in the eUICC; and
remove one or more notifications upon receiving a removing command, the removing command configured to command removal of selected notifications stored in the eUICC, a selection of the selected notifications determined through a selection argument of the removing command, the selection argument comprising selecting all notifications stored in the eUICC for deletion; and
a remote provisioning server or a remote manager module, configured to communicate with a profile assistant module to perform profile state management operation on profiles of the eUICC.

11. The system architecture of claim 10, wherein the remote provisioning server or the remote manager module is the remote provisioning server, and the remote provisioning server is a subscription manager-data preparation enhanced (SM-DP+) module.

12. The system architecture of claim 10, wherein the remote provisioning server or the remote manager module is the remote manager module, and the remote manager module is an eUICC IoT manager (eIM).

13. A method for managing an embedded Universal Integrated Circuit Card (eUICC), in which are stored notifications generated upon a profile operation execution in the eUICC, the method comprising:
managing, by a processor of the eUICC, the notifications; and
removing, by the processor, one or more notifications upon receiving a removing command, the removing command commanding removal of selected notifications stored in the eUICC, a selection of the notifications determined through a selection argument of the removing command, the selection of the notifications determined through the selection argument comprising selecting all notifications stored in the eUICC for deletion.

14. The method according to claim 13, wherein the selection argument is represented by a data object comprising one or more selection criterion of the notifications that indicates which notifications are selected for deletion, removing all the notifications in response to the removing command not including the data object comprising the one or more selection criterion of the notifications.

15. The method according to claim 14, comprising removing all the notifications in response to a parameter of the data object comprising the one or more selection criterion of the notifications being equal to a given value.

16. The method according to claim 13, wherein the eUICC is an embedded subscriber identity module (eSIM) for Internet of Things (IoT) operating according to specification SGP.32 and the removing command is configured to delete all reports on execution of eUICC packages for profile state management stored in the eUICC.

17. The method according to claim 13, wherein the selection argument comprises a parameter represented by a sequence number, which indicates to remove a notification or reports on execution of eUICC packages for profile state management that has a corresponding sequence number value in a list of stored notifications.

18. The method according to claim 13, further comprising marking as read at the eUICC notifications and reports read by a respective recipient entity, and upon receival of the removing command deleting only the marked notifications.

19. The method according to claim 18, comprising, upon receival of the removing command:
selecting a notification or report and checking for a match with one or more selection criterion;
in response to a positive match, further checking whether the notification or report is marked as already retrieved;
in response to the notification or report already being retrieved, deleting the notification or report; and
determining whether there is any notification or report left stored in the eUICC.

20. The method according to claim 18, comprising, upon receival of the removing command:
selecting a notification or report and checking for a match with one or more selection criterion;
in response to a negative match, determining whether there is any notification or report left stored in the eUICC;
in response to a positive determination, selecting a next notification or report among those left stored in the eUICC; and
checking for a match of the next notification or report with the one or more selection criterion.
